(19) United States
(12) Patent Application Publication
(10) Pub. No.: US 2011/0158702 A1
(43) Pub. Date: Jun. 30, 2011

(54) ALTERNATE SCAVENGER GEOMETRY THAT PROMOTES CARRIER RETURN BACK INTO THE DEVELOPMENT STATION

(76) Inventors: Kenneth J. Brown, Penfield, NY (US); Michael T. Dobbertin, Honeoye, NY (US); Dennis J. Grabb, Sodus, NY (US)

(21) Appl. No.: 12/859,549

(22) Filed: Aug. 19, 2010

Related U.S. Application Data
(60) Provisional application No. 61/290,916, filed on Dec. 30, 2009.

(51) Int. Cl. G03G 15/09

(52) U.S. Cl. 399/273

(57) ABSTRACT

A method for recirculating carrier back into a printer developer station by forming a horizontal slot in the face of the scavenger electrode. The carrier is urged through the slot and into the developer station by magnetic force to prevent the build up of carrier on the scavenger.

### CROSS REFERENCE TO RELATED APPLICATION

Reference is made to commonly assigned, co-pending U.S. Patent Applications:

Ser. No. 12/827,261 by Brown et al. (Docket 96396) filed Jun. 30, 2010 entitled “Printer Having An Alternate Scavenger Geometry” and Ser. No. 12/827,305 by Brown et al. (Docket 96397) filed Jun. 30, 2010 entitled “Fabrication Of An Alternate Scavenger Geometry”, the disclosures of which are incorporated herein by reference in their entireties.

This application claims the benefit of U.S. Provisional Patent Application No. 61/290,916 filed Dec. 30, 2009, which is incorporated herein by reference in its entirety.

### FIELD OF THE INVENTION

The present invention pertains to electrographic printers and copiers utilizing developer comprising toner, carrier, and other components.

### BACKGROUND OF THE INVENTION

Electrographic printers and copiers utilizing developer comprising toner, carrier, and other components use a developer mixing apparatus and related processes for mixing the developer and toner used during the printing process. As is well known, the carrier can comprise permanently magnetized ferrite core particles, dispersed in a developer station with toner, whereupon the toner is attracted to and is “carried” by the ferrite core to an imaging roller for printing on a print medium. The gram weight of the carrier can be approximately 6-8% of the toner, which together comprises the developer. As part of this process, the carrier is intended to be reused and recirculated within the developer station. Certain conditions will cause the carrier to leave the developer station and deposit on the surface of the imaging member. Typically, there exists an electrically biased electrode 103 (the scavenger electrode), as shown in FIG. 1, that urges this carrier off the surface of the imaging member 102 because the biasing induces magnetism in the electrode, whereupon the magnetic force of the development roller 101 will direct the carrier, under gravity, back into the development station substantially in the general direction 105. The scavenger is electrically biased via a combination of high frequency AC imposed on a DC waveform whose function is to provide the motive force for the movement of carrier off of the photoconductor surface. Under the alternating AC field, the carrier rocks free and breaks from the photoconductor surface. The magnetic field from the rotating core magnet then pulls the carrier particle through the slotted scavenger back into the developer station

There are conditions, however, that result in the release of the carrier from the imaging (photoconductor) member 102, but the trajectory of the carrier is such that it will overshoot the trailing edge of the electrode 103. This can result in carrier accumulating, shown as 204 in FIG. 2, on the outside vertical face of the scavenger electrode 203 or other surfaces, such as on the outer surfaces of the developer station or other surfaces in the imaging engine. Since this carrier is intended to be reused within the developer station, the loss of carrier can result in degradation of the image due to compromised mixing in developer sump. This carrier loss can also accumulate to the point where this carrier mass 204 can make contact with the imaging member 202, thereby physically disrupting the image, resulting in a loss of image quality.

### SUMMARY OF THE INVENTION

The primary issues solved by the present invention include, first, defining a geometry of the scavenger that allows carrier to be returned to the developer station in the circumstance that the carrier has been successfully scavenged off of the surface of the imaging member and has a trajectory that overshoots the trailing edge of the scavenger electrode. Second, defining a scavenger geometry such that carrier buildup on the vertical face is minimized. Third, defining a scavenger geometry that preserves stiffness (moment of inertia) in both x-x and y-y planes, such that the requirement for straightness of the leading edge of the electrode (about 0.004″ deflection over a length of about 14.5″) can be maintained and, fourth, defining a scavenger geometry that facilitates economical production.

Such advantages are realized in a preferred embodiment of the present invention wherein a method for minimizing magnetized carrier accumulation on a scavenger comprises forming at least one slot through the scavenger and magnetically attracting the carrier through the slot. A source of magnetic force on one side of the scavenger pulls, attracts, and urges the carrier toward the magnetic source. In one preferred embodiment, a plurality of slots is separated by forming a cycloidal inter slot web therebetween. The scavenger is placed such that the earth's gravitational force acts upon the carrier that is magnetically drawn through the slot or slots. After being drawn through the slots(s), the carrier drops downward into the developer station which acts as a collector in this regard by being placed beneath the scavenger's location to capture the falling carrier. The inter slot web is uniquely shaped, having a trapezoidal or cycloidal cross section. The cycloid shape can generally be described as triangular wherein two sides are curved in a concave formation and the third side comprises the predominant flat side. One corner of the triangle shape also comprises a flat side but this dimension is about 1 to 3 mm wide and so comprises a minor flat side. A trapezoidal inter slot web has been found to function substantially as intended by the present invention, even though the cycloidal shape is preferred.

Another preferred embodiment of the present invention comprises a method of operating an electrostatographic printer wherein a rotating member collects magnetized carrier upon its outside surface which is then removed by a scavenger disposed proximately to the member while it is rotating. The scavenger includes a slot for the carrier to be drawn through by a source of magnetic field. The scavenger can be formed to include a plurality of slots separated by an inter slot web. The inter slot web comprises a trapezoidal cross section having two parallel sides wherein a shorter one of the two parallel sides is situated on a side of the scavenger where the carrier collects. The inter slot web can also be formed to have a cycloidal cross section. The cycloid has a predominant flat side and a minor flat side, as explained above, where the predominant flat side is situated on a side of the scavenger nearer the magnetic field source and opposite a side where the carrier collects. The scavenger is situated so that earth gravity acts upon carrier that is magnetically drawn through the slot and causes it to drop. A developer station container then captures the falling carrier.

Another preferred embodiment of the present invention includes a method of retrieving magnetized particles. This method comprises fabricating a pathway for magnetized particles and then magnetically attracting, urging, drawing, or pulling the magnetized particles along the pathway. In a preferred embodiment of the present invention the pathway includes slots formed in a printer scavenger wherein the particles are used for delivering toner to an imaging roller in the printer wherein the magnetized particles are captured after a printing step by being dropped into a collector and recirculated in a developer station. The pathway can include a plurality of slots through a scavenger wherein the slots are separated by an inter slot web shaped as a trapezoid or as a cycloid.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. For example, the summary descriptions above are not meant to describe individual separate embodiments whose elements are not interchangeable. In fact, many of the elements described as related to a particular embodiment can be used together with, and possibly interchanged with, elements of other described embodiments. Many changes and modifications may be made within the scope of the present invention without departing from the spirit thereof, and the invention includes all such modifications. The figures below are intended to be drawn neither to any precise scale with respect to relative size, angular relationship, or relative position nor to any combinational relationship with respect to interchangeability, substitution, or representation of an actual implementation.

### BRIEF DESCRIPTION OF THE DRAWINGS

FIG. 1: Depiction of carrier scavenger electrode and electrostatographic module components;

FIG. 2: Scavenger electrode showing carrier buildup;

FIG. 3: Depiction of horizontal slots cut into vertical face of the scavenger electrode;

FIGS. 4A-B: Depiction of inside and outside vertical surfaces of the scavenger electrode and slot form options;

FIG. 5: Graph of inter slot web angle vs. magnetic field;

FIG. 6: Depiction of total included angle of inter slot web;

FIG. 7: Specification for inter web slots of a trapezoidal design;

FIG. 8: Top view of scavenger electrode showing slot geometry;

FIG. 9: Specification drawing for slots of a cycloidal design;

FIG. 10: Depiction of how carrier covers a greater area of the electrode surface when process speed is increased;

FIG. 11: Depiction of carrier buildup on inter slot webs.

FIG. 12: Depiction of improved geometry.

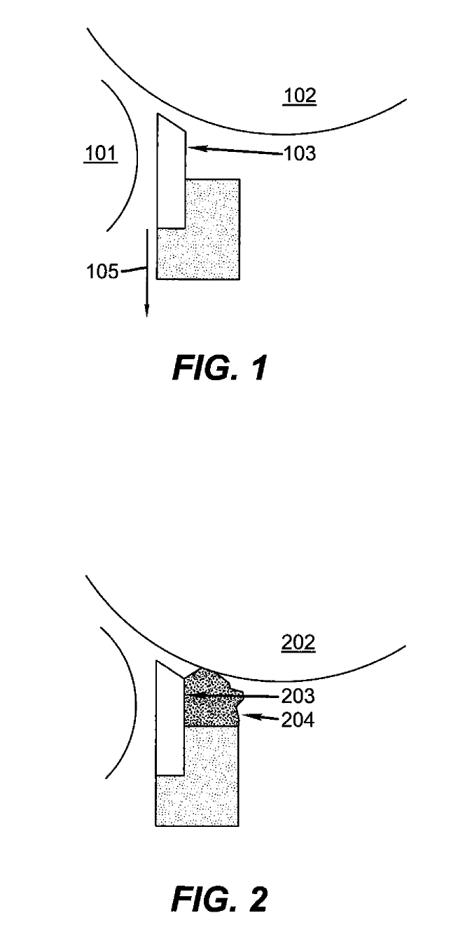

### DETAILED DESCRIPTION OF THE INVENTION

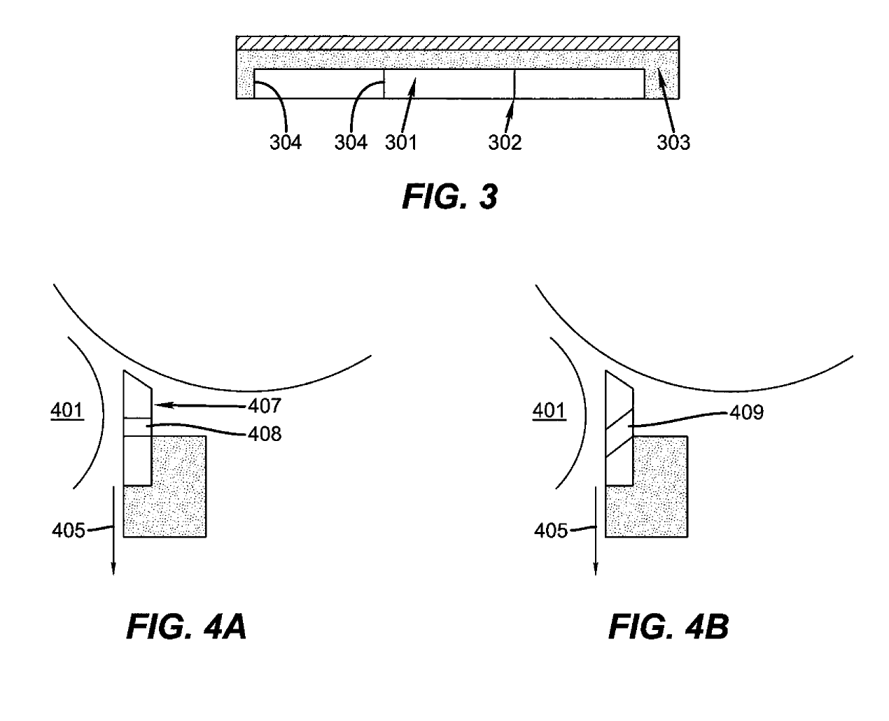

A preferred embodiment of the present invention provides return of carrier back into a printer's developer station by forming horizontal slots (separated by inter slot webs) through the vertical face of the scavenger electrode, as illustrated in FIG. 3 which shows a front view of the scavenger electrode as seen while looking at the outside vertical face 303. A preferred embodiment of these slots 301, having sidewalls 304, formed through the scavenger electrode comprise slots defined as follows:

Slot (sidewall) height: range from 3.2 mm to 5.5 mm, or 36% to 61% of the vertical face height of the Scavenger Electrode (approx. 9 mm vertical wall height). The interior and exterior vertical faces of the slots can be referred to as sidewalls.

Slot Width: range of 20 mm-30 mm.

Total slot area is 20%-30% of the total area of the inside vertical face of the scavenger electrode. Carrier buildup on the outside vertical face of the scavenger electrode is minimized by reducing the projected area of the inter slot web 302 on the outside vertical face. Scavenger stiffness is increased by maximizing the projected area of the inter slot web's inside vertical face of the scavenger electrode, as will be explained.

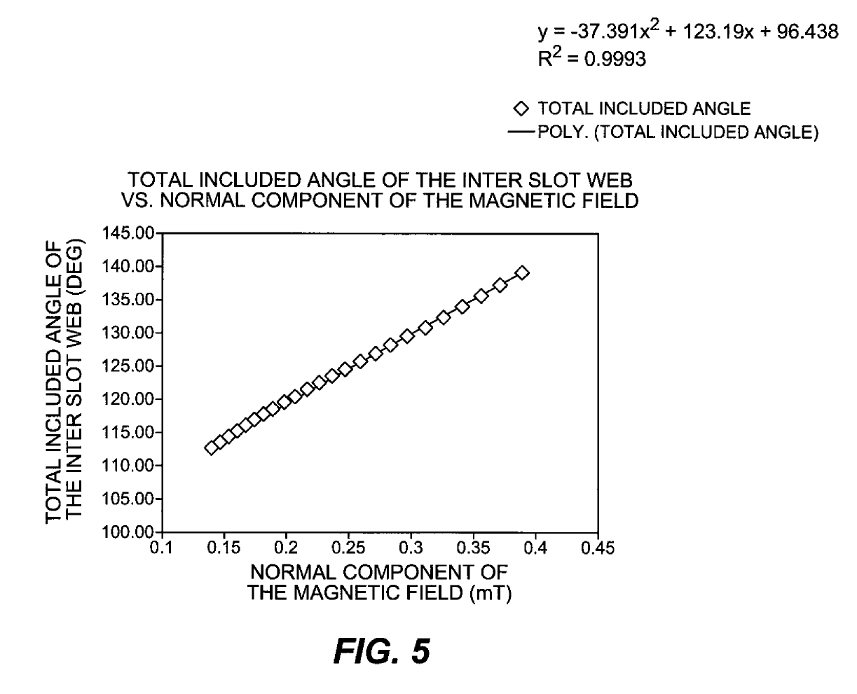

Referring to FIG. 4A, buildup of carrier on the outside vertical face 407 of the scavenger electrode is minimized when the total included angle of the inter slot web is proportional to the normal component of the magnetic field imposed by the development roller 401 on the built up carrier. This draws the carrier along a pathway from where the carrier accumulates 204 through the slots 408 which is then returned by earth gravitational force in direction 405 back to the developer station. An optional slot configuration is illustrated in FIG. 4B wherein the slot 409 is angled downward which requires less attractive force from the magnetic field provided by the development roller 401 to move the carrier out of the scavenger in the direction 405. This is due to gravity acting on the carrier and causing the carrier to travel through the slot. The magnetic field imposed by the development roller 401 is sufficiently described, with R²=99.93%, per the following equation, supported by data shown in FIG. 5.

TIA=37.391×FIELD²+123.91×FIELD+96.438, where

TIA=Total Included Angle (in Degrees)

Field=Normal Component of Magnetic Field (in mT)

where TIA≦139 Deg

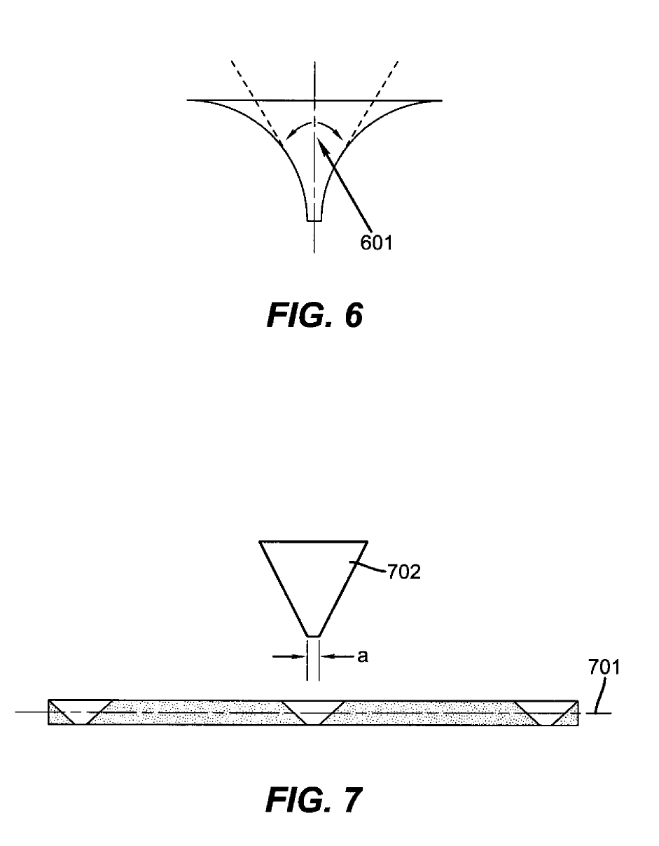

The total included angle 601 is measured rail to rail as shown in FIG. 6 which illustrates a top view of a single inter slot web.

In general, slots that use a trapezoidal geometry for the inter slot web can partially satisfy the requirements of returning carrier back into the developer station, minimizing carrier buildup on the outside vertical face of the scavenger electrode, and increasing overall stiffness of the scavenger as compared to an inter slot web having a constant thickness. The requirements for the trapezoidal geometry of the inter slot web are described as follows and are shown in the top view of the scavenger electrode depicted in FIG. 7. The ‘a’ dimension of the trapezoid 702 faces the outside vertical face of the scavenger electrode. The length of the ‘a’ dimension is preferably less than or equal to about 1.5 mm. The total calculated moment of inertia about the specified axis of interest 701, as illustrated in FIG. 7 for the inter slot web should be about 58 mm̂4. The total included angle of the inter slot web geometry provided by the trapezoidal inter slot web should partially satisfy requirements for allowing a return of built up carrier to the developer station.

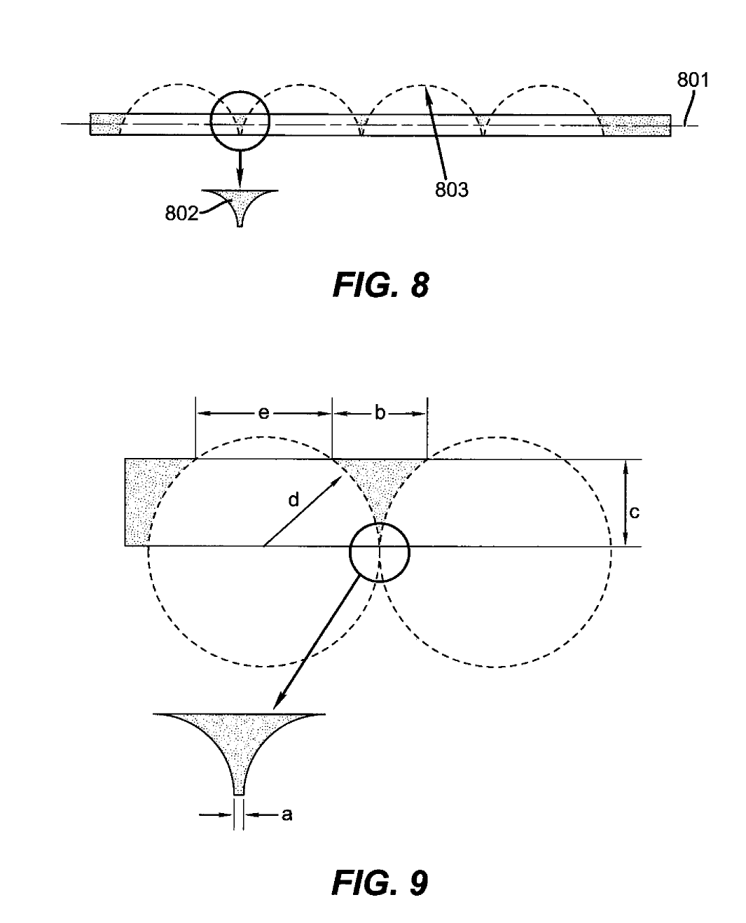

Another preferred embodiment of the inter slot web is to cut or form openings in a fashion that describes a cycloid (cusp at origin) such as illustrated in FIG. 6, depicted in greater detail in FIGS. 8 and 9, with the addition of the following.

The profile of the inter slot web is thinner than the equivalent trapezoidal inter slot web towards the outside vertical face of the scavenger electrode, which further discourages carrier buildup on the outside face of the scavenger electrode because the favorable cycloidal geometry presents less resistance to the carrier when it is drawn through the slots by magnetic force from the development roller. This can be seen by comparing FIG. 7 with FIG. 8 where the cycloid inter slot web 802 is thinner in the trapezoidal inter slot web 702 “a” dimension. The cycloidal slots 803 are defined by the following dimensions, with reference to FIG. 9 which shows a top view of the scavenger electrode:

In an experimental laboratory construction, the following dimensions were found to provide improved scavenger performance. The ‘a’ dimension is of the apex of the inter slot web that faces the outside vertical edge of the scavenger electrode. The length of the ‘a’ dimension should be less than or equal to about 1.5 mm, but within a range of about 1-2mm. The ‘b’ dimension should be about 49.2 mm, but within a range of about 47-52 mm; the ‘c’ dimension should be about 4.78 mm, but within a range of abut 3-6 mm; and the ‘d’ dimension should be about 50.8 mm, but within about 47-53 mm. Slot height can range from about 3 mm to about 6 mm (36% to 61%) of the vertical face of the scavenger electrode (approx. 9 mm vertical wall height). Slot width (dimension ‘e’) ranges from about 20-30 mm. Total slot area should be about 20%-30% of the total area of the vertical face of the scavenger. The total calculated moment of inertia about the specified axis of interest 801 for the inter slot should be about 58 mm̂4, as depicted in FIG. 8. The dimensions just described were measured for a scavenger electrode manufactured for a printer having a size of approximately 454 mm in length. The length of the scavenger is consistent with the maximum imaging width of the particular print process, and should not be considered as required dimensions for implementations in any other printer.

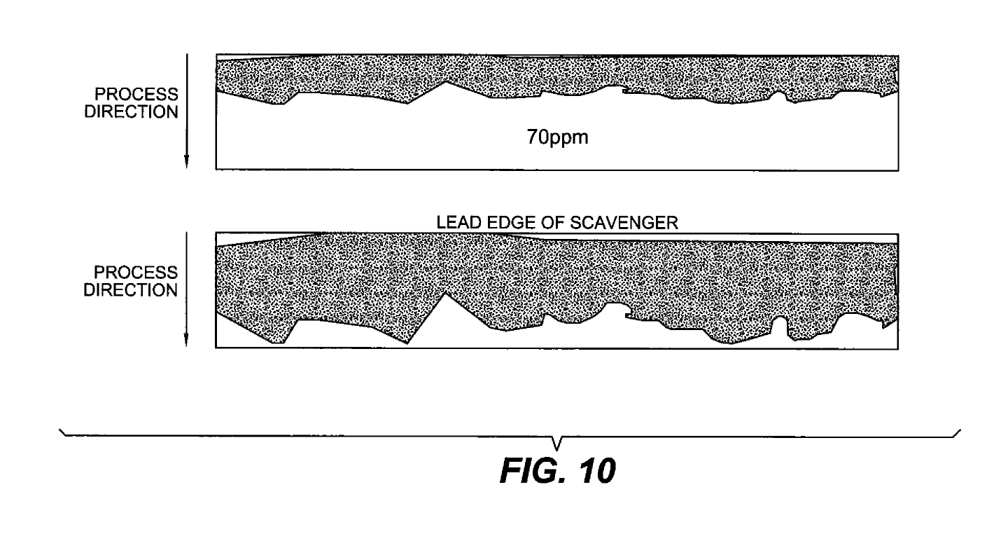

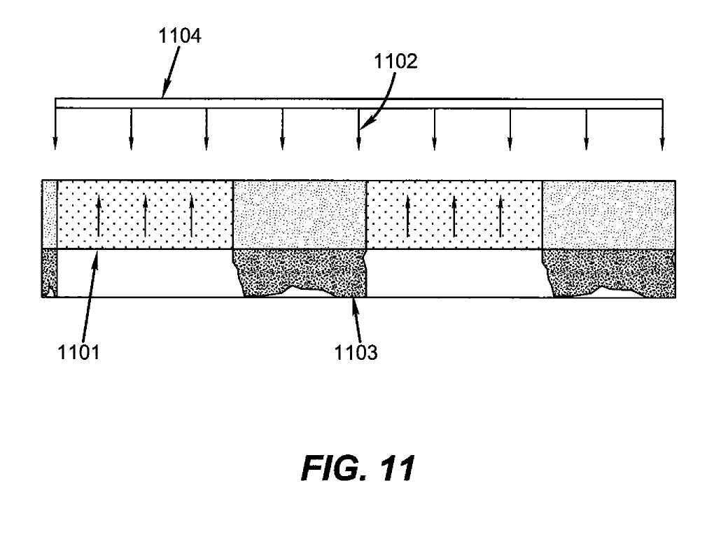

In a two component development system, some loss of carrier is inevitable, and management of carrier loss turns out to be a very important part of the development station design. Specifically, the need to effectively scavenge escaping carrier and return it back to the development station is crucial to the overall life of the developer. It has been shown that as the speed of the electrostatographic process is increased, the trajectory of the carrier is such that it landed farther downstream from the developer station resulting in increased build up, as depicted in FIG. 10, which depicts build up amounts for print speeds of 70 ppm and 100 ppm (pages per minute).

It is essential to place the scavenger electrode at the point where the influence of the developer station magnet is such that it could no longer urge the carrier back into the developer station. As the speed of the process continues to increase, the trajectory of the carrier is such that a large portion of the scavenged carrier lands far past the trail edge of the scavenger electrode. This results in carrier accumulating on the scavenger and associated mounting surfaces, and results in increased maintenance and eventual degradation in image quality. The mass of escaping carrier is such that a simple strategy of placing a tray downstream of the developer station to catch and collect the carrier is unmanageable, since it is not guaranteed that escaping carrier caught in the external tray would be returned to the developer station. A practical solution requires that the majority of this escaping carrier be returned back to the developer station.

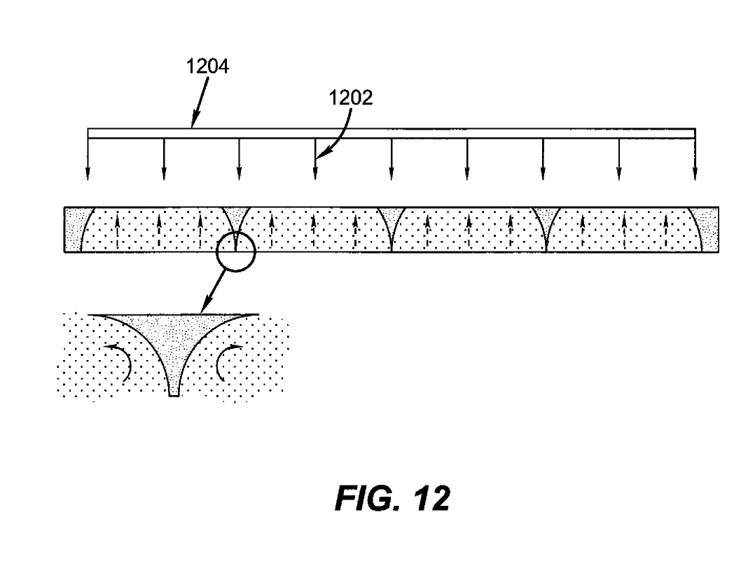

Initial attempts at a solution involved drilling holes and cutting slots into the vertical face of the scavenger electrode. This resulted in a vast majority of the carrier returning back to the developer station. This design was not completely effective, because the inter slot web areas accumulated carrier to the point where it would make contact with the imaging member surface, causing an image defect. With reference to FIG. 12, this geometry for the inter slot web was ineffective because the magnetic field 1202 is normal to the vertical surface of the scavenger, such that there is no force to urge the carrier 1203 to move in the transverse direction (along the face of the scavenger electrode). The carrier is urged in the direction 1201 through the slot by the magnetic field. Thus, the carrier is held tight on the horizontal face of the inter slot web, as depicted in FIG. 12.

With reference to FIG. 13, the addition of the cycloidal inter slot web urges the carrier in transverse direction (along the length of the cycloidal inter slot web) and through the openings, allowing for the proper return of carrier back into the development station. The angle of the inter slot web increases and approaches an angle normal to the magnetic field where the magnetic field is stronger and able to overcome this increased resistance. Where the magnetic field is weaker, near the apex of the inter slot web, the inter slot web geometry is almost parallel to the magnetic field lines and provides very little resistance to the movement of the carrier. This geometry also preserves the required rigidity and stiffness of the scavenger electrode over other web geometries. In particular, the wider profile of the inter slot web on the inside surface of the scavenger provides this increased rigidity. With the geometry described by the present invention, this buildup is substantially eliminated.

It will be understood that, although specific embodiments of the invention have been described herein for purposes of illustration and explained in detail with particular reference to certain preferred embodiments thereof, numerous modifications and all sorts of variations may be made and can be effected within the spirit of the invention and without departing from the scope of the invention. Accordingly, the scope of protection of this invention is limited only by the following claims and their equivalents.

1. A method for minimizing magnetized carrier accumulation on a scavenger comprising:
forming a slot through the scavenger; and
magnetically urging the carrier through the slot.

2. The method of claim 1 wherein the step of magnetically urging further comprises placing a source of magnetic force on a side of the scavenger that is opposite a side of the scavenger where the carrier accumulates.

3. The method of claim 1 wherein the step of forming a slot comprises forming a plurality of slots and forming an inter slot web, wherein the plurality of slots are separated by the inter slot web.

4. The method of claim 1 further comprising the step of situating the scavenger such that earth gravity acts upon carrier that is magnetically urged through the slot.

5. The method of claim 2 further comprising the step of situating the scavenger and the source of magnetic force such that earth gravity acts upon carrier that is magnetically urged through the slot.

6. The method of claim 4 further comprising the step of situating a developer station for receiving the carrier that is magnetically urged through the slot.

7. The method of claim 3 wherein the inter slot web comprises a cycloid shaped cross section and the step of forming the inter slot web comprises situating a predominant flat side of the cycloid on a side of the scavenger that faces the source of magnetic force.

8. The method of claim 1 wherein the step of forming a slot comprises forming a plurality of slots and forming a trapezoidal inter slot web, wherein the plurality of slots are separated by the trapezoidal inter slot web.

9. The method of claim 8 wherein the trapezoidal inter slot web comprises a trapezoid shaped cross section having two parallel sides and the step of forming the trapezoidal inter slot web comprises situating a shorter one of the two parallel sides on a side of the scavenger where the carrier accumulates.

10. A method of operating an electrostatographic printer comprising the steps of
rotating a member whereupon magnetized carrier collects;
disposing a scavenger proximate the member for removing the carrier from the member during the step of rotating, the scavenger comprising a slot therethrough; and
magnetically urging carrier that has landed on the scavenger through the slot during the step of rotating.

11. The method of claim 10 wherein the step of magnetically urging comprises disposing a source of magnetic force proximate the carrier for urging the carrier toward the source of magnetic force.

12. The method of claim 10 wherein the scavenger comprises a plurality of slots therethrough, and wherein the plurality of slots are separated by an inter slot web.

13. The method of claim 12 wherein the inter slot web comprises a trapezoidal cross section having two parallel sides, and wherein a shorter one of the two parallel sides is situated on a side of the scavenger where the carrier collects.

14. The method of claim 12 wherein the inter slot web comprises a cycloidal cross section having a predominant flat side, and wherein the predominant flat side is situated on a side of the scavenger opposite a side where the carrier collects.

15. The method of claim 10 further comprising the step of situating the scavenger such that earth gravity acts upon carrier that is magnetically urged through the slot.

16. The method of claim 15 further comprising the step of situating a developer station for receiving the carrier that is magnetically urged through the slot.

17. A method of retrieving magnetized particles, comprising:
fabricating a pathway for the magnetized particles; and
magnetically urging the magnetized particles along the pathway.

18. The method of claim 17, further comprising the steps of:
using the magnetized particles for delivering toner in a printing process; and
capturing the magnetized particles in a collector after the step of magnetically urging.

19. The method of claim 18, wherein the step of capturing comprises the step of dropping the magnetized particles into the collector after the step of magnetically urging.

20. The method of claim 17, wherein the step of fabricating a pathway comprises fabricating a cycloidal inter slot web.
